(19) United States
(12) Patent Application Publication
(10) Pub. No.: US 2015/0109998 A1
(43) Pub. Date: Apr. 23, 2015

(54) METHOD OF PERFORMING HYBRID AUTOMATIC REPEAT REQUEST OPERATION FOR RANDOM ACCESS RESPONSE MESSAGE

(71) Applicant: Alcatel Lucent, Boulogne Billancourt (FR)

(72) Inventor: Tao Yang, Shanghai (CN)

(73) Assignee: ALCATEL LUCENT, Boulogne Billancourt (FR)

(21) Appl. No.: 14/382,465

(22) PCT Filed: Feb. 27, 2013
(86) PCT No.: PCT/IB2013/000603

§ 371 Date: Sep. 2, 2014

(30) Foreign Application Priority Data
Mar. 2, 2012 (CN) 201210053838.8

(51) Int. Cl. H04W 74/08; H04W 74/00

(52) U.S. Cl. CPC H04W 74/0833; H04W 74/004; H04W 74/008
USPC 370/328

(57) ABSTRACT

The invention proposes a method of performing a hybrid automatic repeat request operation for a random access response message. The method at the base station includes the steps of: receiving a contention free random access preamble from a user equipment; transmitting a random access response message to the user equipment in a first media access control protocol data unit; transmitting a second media access control protocol data unit to the user equipment in a hybrid automatic repeat request process of the first media access control protocol data unit including the random access response message, wherein a physical control channel corresponding to the second media access control protocol data unit includes an indicator for indicating that the second media access control protocol data unit includes new data, the indicator being used for indicating whether the media access control protocol data unit is transmitted for a first time or retransmitted.

### FIELD OF THE INVENTION

The present disclosure relates to a random access response message and particularly to a method, in a base station and a user equipment, of performing a hybrid automatic repeat request operation for a random access response message.

### BACKGROUND OF THE INVENTION

In the current discussion of 3GPP Rel-11, there are two candidates to transmit the RAR of Scell. The first one is to address Physical Downlink Control Channel (PDCCH) for message 2 (Msg2, i.e., the RAR message) based upon RA-RNTI over Common Searching Space (CSS) of Pcell, and the second one is to address PDCCH for message 2 (Msg2, i.e., the RAR message) based upon C-RNTI over UE-specific Searching Space (USS) of Pcell or Scell configured with PDCCH.

### SUMMARY OF THE INVENTION

In a Contention Free Random Access (CFRA) process, firstly the user equipment transmits a preamble to the base station; and then the base station feeds back the Random Access Response (RAR) message to the user equipment upon reception of the random access preamble from the user equipment. Since PDCCH for message 2 (Msg2, i.e., the RAR message) is addressed based upon C-RNTI over UE-specific Searching Space (USS) of Pcell or Scell configured with PDCCH in the foregoing second approach, the RAR message is transmitted in the form of MAC PDU, so Hybrid Automatic Repeat reQuest (HARQ) mechanism can also be applicable to transmission of the RAR. However no HARQ mechanism for MAC PDU in which the RAR message is borne has been proposed in the prior art. Thus the invention is intended to provide a simple and feasible RAR HARQ mechanism.

According to a first aspect of the invention, there is provided a method, in a base station, of transmitting a random access response message to a user equipment, the method including the steps of: A. receiving a contention free random access preamble from the user equipment; B. transmitting a random access response message to the user equipment in a first media access control protocol data unit; C. transmitting a second media access control protocol data unit to the user equipment in a hybrid automatic repeat request process of the first media access control protocol data unit including the random access response message, wherein a physical control channel corresponding to the second media access control protocol data unit includes an indicator for indicating that the second media access control protocol data unit includes new data, the indicator being used for indicating whether the media access control protocol data unit is transmitted for a first time or retransmitted.

According to a second aspect of the invention, there is provided a method, in a base station, of transmitting a random access response message to a user equipment, the method including the steps of: A. receiving a contention free random access preamble from the user equipment; B. transmitting a random access response message to the user equipment in a media access control protocol data unit; and C. retransmitting the media access control protocol data unit including the random access response message to the user equipment upon reception of a negative acknowledgement message from the user equipment or when no feedback from the user equipment is received in a predetermined period.

According to a third aspect of the invention, there is provided a method, in a user equipment, of processing a random access response message from a base station, the method including the steps of: I. transmitting a contention free random access preamble to the base station serving the user equipment; II. receiving from the base station the random access response message transmitted in a media access control protocol data unit; III. determining whether the random access response message satisfies a predetermined validity condition; and IV. determining that the random access response message is valid when the random access response message satisfies the predetermined validity condition.

With the inventive solution, the HARQ mechanism for MAC PDU in which the RAR message is borne is addressed.

### BRIEF DESCRIPTION OF DRAWINGS

Other features, objects and advantages of the invention will become more apparent upon review of the following description of non-limiting embodiments made with reference to the drawings in which:

FIG. 1 illustrates a flow chart of a system method according to an embodiment of the invention; and

FIG. 2 illustrates a flow chart of a system method according to another embodiment of the invention

Throughout the drawings, identical or similar reference numerals will denote identical or similar step features or devices/modules.

### DETAILED DESCRIPTION OF EMBODIMENTS

In the second approach to transmit the RAR as mentioned above, that is, the key issue of being based upon USS of any active cell is how to operate HARQ process for the RAR. This issue refers to how to cope with UL grant present in the RAR payload. These issues will be discussed below respectively in terms of RAR without HARQ retransmission and RAR with HARQ retransmission.

### First Embodiment

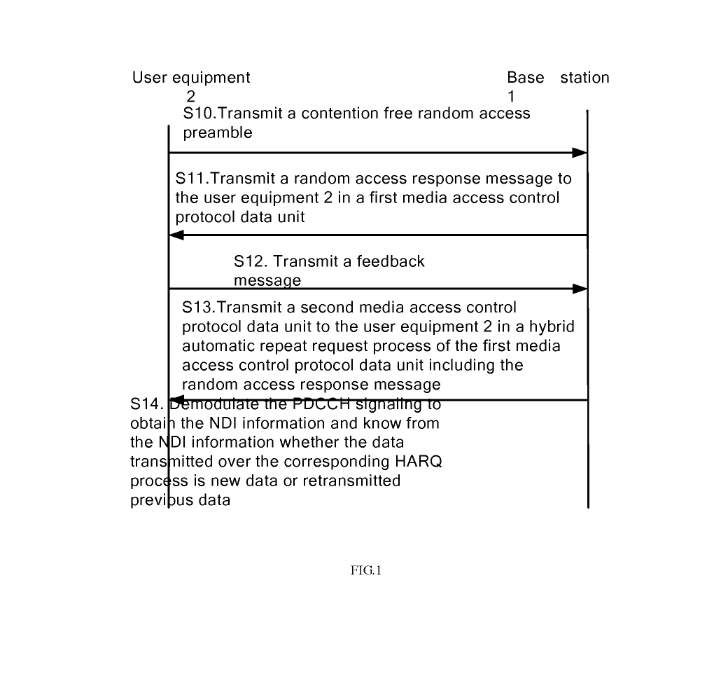

Referring to FIG. 1, first, in the step S10, the user equipment 2 transmits a contention free random access preamble to the base station 1 serving the user equipment 2.

In the step S11, the base station 1 transmits a random access response message to the user equipment 2 in a first Media Access Control Protocol Data Unit (MAC PDU) upon reception of the contention free random access preamble from the user equipment 2.

Then in the step S12, the user equipment 2 transmits a feedback message, e.g., an ACK or NACK message, to the base station 1 upon reception of the first MAC PDU from the base station 1.

Then in the step S13, the base station 1 transmits a second media access control protocol data unit to the user equipment 2 in a hybrid automatic repeat request (HARQ) process of the first media access control protocol data unit including the random access response message, wherein a physical downlink control channel corresponding to the second media access control protocol data unit includes an indicator for indicating that the second media access control protocol data unit includes new data, the indicator being used for indicating whether the media access control protocol data unit is transmitted for a first time or retransmitted.

The PDCCH includes HARQ related information, where the New Data Indicator (NDI) in the

PDCCH indicates whether the MAC PDU includes new data, that is, the PDCCH channel corresponding to the HARQ process indicates whether the data in the MAC PDU is transmitted for a first time or retransmitted. The NDI is represented by 1-bit data. In an embodiment of the invention, the NDI is set all the time as having transmission of new data enabled. That is, the value of the NDI is changed from the value of the NDI transmitted last time, for example, the value of the NDI is changed from 0 to 1, or the value of the NDI is changed from 1 to 0.

In this embodiment, the second MAC PDU is transmitted in the HARQ process corresponding to the first MAC PDU. However the NDI of the PDCCH corresponding to the HARQ process for transmitting the second MAC PDU is set to be different from the NDI of the PDCCH corresponding to the HARQ process for transmitting the first MAC PDU, that is, it indicates that there is new data being transmitted. That is, if the value of the NDI in PDCCH signaling corresponding to the HARQ process for transmitting the first MAC PDU is 1, then the value of the NDI in PDCCH signaling corresponding to the HARQ process for transmitting the second MAC PDU shall be 0. Alternatively if the value of the NDI in PDCCH signaling corresponding to the HARQ process for transmitting the first MAC PDU is 0, then the value of the NDI in PDCCH signaling corresponding to the HARQ process for transmitting the second MAC PDU shall be 1.

The new data included in the second MAC PDU can be the RAR information encapsulated in the first MAC PDU or can be other data information.

For the first embodiment, the base station 1 can define that there is no HARQ retransmission for the RAR. The base station 1 can schedule new transmission over the HARQ process of the previously transmitted RAR regardless of whether the base station 1 receives the ACK or the NACK from the user equipment 2. Thus, although the step S13 is described as being subsequent to the step S12 in this specification, those skilled in the art can appreciate that there is no apparent sequential order between the step S12 and the step S13, and the base station 1 may not necessarily trigger transmission of the second MAC PDU only after receiving the feedback from the user equipment 2 for the first MAC PDU. In other words, for the HARQ process of the RAR, the base station will initiate transmission of the new data regardless of whether the feedback the base station receives from the user equipment is ACK or NACK. Furthermore the base station will also initiate transmission of the new data if the base station does not receive any feedback for more than 8 ms.

For the base station 1, if the base station 1 receives the NACK from the user equipment 2 for the MAC PDU in which the RAR is borne or receives no feedback from the user equipment 2 in a predetermined period, then the base station 1 knows that the UL grant included in the previous RAR can be reused now. Moreover, if the RAR is to be retransmitted, then the new UL grant shall be reallocated. Alternatively the base station 1 can release the uplink resource corresponding to the UL grant in the first MAC PDU.

Then in the step S14, the user equipment 2 first demodulates the PDCCH signaling upon reception of the second MAC PDU from the base station 1. The user equipment 2 obtains the NDI information from the demodulated PDCCH, and the user equipment 2 can know from the NDI information whether the data transmitted over the corresponding HARQ process is new data or retransmitted previous data.

For example, if the value of the NDI in the PDCCH signaling, received by the user equipment 2, corresponding to the HARQ process for transmitting the second MAC PDU is changed from the value of the NDI in the PDCCH signaling, received by the user equipment 2, corresponding to the HARQ process for transmitting the first MAC PDU have changed, for example, if the value of the NDI in the PDCCH signaling corresponding to the HARQ process for transmitting the first MAC PDU is 0, and the value of the NDI in the PDCCH signaling corresponding to the HARQ process for transmitting the second MAC PDU is 1; or if the value of the NDI in the PDCCH signaling corresponding to the HARQ process for transmitting the first MAC PDU is 1, and the value of the NDI in the PDCCH signaling corresponding to the HARQ process for transmitting the second MAC PDU is 0, then the user equipment 2 knows that relevant HARQ retransmission has been terminated and the user equipment 2 starts to receive the new data without any HARQ merging.

From this perspective, the performance of receiving the RAR, e.g., the delay in receiving the RAR, is the same as in the R10. If the RAR can not arrive at the user equipment 2 in the RAR reception window of the user equipment 2, then the base station 1 will terminates transmission of the RAR. Furthermore, from the perspective of the user equipment 2, if the RAR is decoded correctly in the current reception window of the user equipment 2, then the RAR is valid and the CFRA is finished; otherwise, the RAR is regarded as being invalid and thus discarded.

Since there is no HARQ retransmission of the RAR, the UL grant is valid for the user equipment 2 when the relevant RAR is received correctly.

If HARQ retransmission is performed, then operations in a second embodiment to be discussed later will be performed.

### Second Embodiment

The second embodiment refers to the RAR with HARQ transmission, which is also controlled by the base station 1. From the perspective of the user equipment 2, if the RAR is received outside of its RAR reception window, then it will be regarded as an invalid RAR and thus discarded. On the other hand, if the RAR is received within its RAR reception window, then the RAR will be regarded as a valid RAR and the corresponding random access process will be regarded as a success.

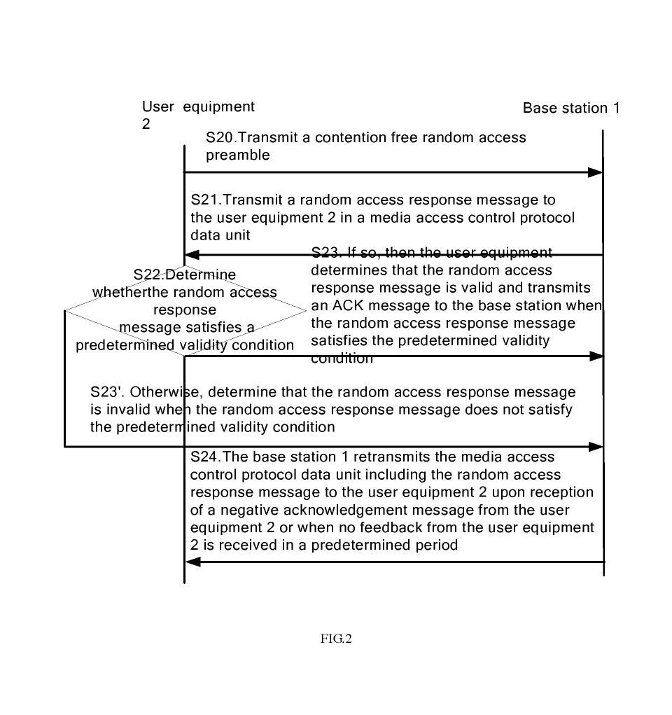

Referring to FIG. 2, in the second embodiment, first, in the step S20, the user equipment 2 transmits a contention free random access preamble to the base station 1 serving the user equipment 2.

In the step S21, the base station 1 transmits a random access response message to the user equipment 2 in a media access control protocol data unit upon reception of the contention free random access preamble from the user equipment 2.

Then the user equipment 2 receives from the base station 1 the random access response message transmitted in the media access control protocol data unit.

Then in the step S22, the user equipment 2 determines whether the random access response message satisfies a predetermined validity condition.

In the step S23, the user equipment 2 determines that the random access response message is valid when the random access response message satisfies the predetermined validity condition.

Otherwise in the step S23′, the user equipment 2 determines that the random access response message is invalid when the random access response message does not satisfy the predetermined validity condition.

Then in the step S24, the base station 1 retransmits the media access control protocol data unit including the random access response message to the user equipment 2 upon reception of a negative acknowledgement message from the user equipment 2 or when no feedback from the user equipment 2 is received in a predetermined period.

In the prior art, RAR confusion may occur at the side of the user equipment 2 due to HARQ retransmission. For example, the user equipment 2 has to distinguish between the RAR for the previous random access window and the RAR for the current random access window. This may occur in such a scenario that the user equipment 2 has started a new round of preamble transmission, but the RAR reception window for acknowledging the previous round of preamble transmission has been closed and the RAR has not been received correctly, for example, the relevant RAR is still being transmitted via an air interface due to HARQ retransmission. Then in the new RAR reception window, the user equipment 2 receives the RAR for acknowledging the previous round of preamble transmission correctly due to a plurality of HARQ transmission. Thus the user equipment 2 has to identify correctly that the RAR does not correspond to the current RAR reception window as expected.

Thus the user equipment 2 can be configured with the following three options to determine whether the RAR is valid for the user equipment 2. The steps S21 to S24 will be described below respectively for these three options.

1. Determine Validity of Random Access Response Message

In the option 1, reception time when the base station receives the preamble is included in the RAR MAC CE.

Thus, the predetermined validity condition includes: the random access response message further including reception time when the base station 1 receives the contention free random access preamble from the user equipment 2, and the user equipment 2 decoding the random access response message successfully and determining that the random access response message is valid according to the reception time when the base station 1 receives the contention free random access preamble from the user equipment 2 and a reception window of the current random access response message.

Particularly the reception window of the current RAR refers to the time window in which the user equipment 2 expects to receive the current RAR, and the reception time when the base station 1 receives the preamble refers to the moment when the base station 1 receives the preamble from the user equipment 2. Some specific information, e.g., the reception time when the base station 1 receives the relevant preamble, can be included in the MAC CE of the RAR. It is to be noted that the format of the new MAC CE still needs to be further studied. Thus the MAC CE can be defined to include such information without incurring any extra overhead. For the second approach to transmit the RAR, PDCCH for message 2 (Msg2, i.e., the RAR message) is addressed based upon C-RNTI over UE-specific Searching Space (USS) of Pcell or Scell configured with PDCCH, and only the Time Alignment (TA) is required in the MAC PDU of the RAR. The traditional RAR payload is 6 bytes. Thus excluding the TA field, there are 36 bits available when there is no UL grant field or 16 bits available when the UL grant field is kept. Even in the latter case, 2¹⁶=6536 TTIs can be identified, which is far more than necessary.

Thus in the step S21, the RAR MAC PDU transmitted from the base station 1 to the user equipment 2 further includes the reception time when the base station 1 receives the contention free random access preamble from the user equipment 2.

In the step S22, the use equipment 2 determines whether the reception time when the base station 1 receives the preamble satisfies a predetermined relationship with the reception window of the current RAR according to the reception time when the base station 1 receives the preamble, in the RAR MAC PDU, and the reception window of the current RAR. Generally the reception time when the base station 1 receives the preamble is at 4 ms after the user equipment 2 transmits the preamble, so the reception time when the base station 1 receives the preamble can typically fall within the reception window of the RAR. For example, it can be determined whether the reception time when the base station 1 receives the preamble is within the reception window of the current RAR. If the reception time when the base station 1 receives the preamble in the RAR indicates that the RAR is the expected RAR, then in the step S23, the user equipment 2 determines that the RAR is valid; otherwise, in the step S23′, the base station 1 determines that the RAR is invalid and shall be discarded.

In the option 2, the user equipment estimates reception time when the MAC PDU including the RAR is received for the first time.

For this option, if the RAR is decoded correctly, then the user equipment 2 estimates reception time when the MAC PDU including the RAR is received for the first time. This is helpful for the user equipment 2 to decide when the RAR shall be received without HARQ retransmission.

If the first-time reception time is within the reception window of the current RAR, then the RAR is the expected one. On the other hand, if the first-time reception time is outside the reception window of the current RAR, then the RAR is invalid, and the user equipment 2 shall discard it accordingly.

For this option, the reception time when the MAC PDU is received for the first time is a Transmission Time Interval (TTI) where the data is received over the corresponding HARQ process with the value of the NDI in the PDCCH being changed from the previous value thereof. Generally the data can be retransmitted in eight HARQ processes. Thus, for example, in the step S22, the user equipment 2 starts to record the moment when the corresponding NDI is changed in each HARQ process after the RAR reception window is triggered, and then determines the moment when the RAR is received for the first time as the moment (TTI) when the NDI is changed recently in the HARQ process including the RAR. With this scheme, the user equipment 2 can definitely identify whether the received RAR is correct, and the influence of HARQ retransmission on RAR reception can be addressed. This means that the user equipment 2 only needs to record some TTI information without performing any other task. Thus the user equipment 2 will not perform any highly complex operation.

In the option 3, TA validity is estimated.

On the other hand, if the TA can be valid for a longer period, then the random access response message will also be valid for a longer period. For example, if the user equipment 2 decodes the RAR correctly, the user equipment 2 will use the TA included in the RAR for uplink transmission regardless of whether the RAR corresponds to the previous or current random access window, and the current random access process can be regarded as a success.

If the user equipment 2 receives a new RAR later, even after the random access process is terminated, then the user equipment 2 can consider that the RAR has been invalid and thus discard the RAR. Alternatively the user equipment can consider that the RAR is valid and use the TA in the RAR again. Thus RAR reception will not be influenced due to HARQ retransmission.

Or some information can be included in the RAR MAC CE like the option 1, so that the user equipment 2 can know whether the received TA is valid. If so, then the user equipment 2 uses the TA directly regardless of whichever random access reception window it corresponds to.

Alternatively the user equipment can disregard the validity of the TA. The user equipment considers all the time that the RAR message is valid so long as the user equipment decodes the RAR correctly, and uses the TA value in the correctly recorded RAR message for uplink transmission.

From this perspective, the random access window is just to let the user equipment 2 know when to trigger the next round of preamble transmission without any influence on random access reception.

The foregoing three potential options will not influence any TAT operation. When the TA is applied, the TAT operation is (re)started by the user equipment 2. At the base station side, when the ACK for the MAC PDU including the RAR is received by the base station 1 and the base station 1 considers that the user equipment 2 will apply the corresponding TA value, the related TAT operation is (re)started.

The issue of how to determine whether the RAR is valid has been discussed above, and how to process an uplink grant process when UL grant is included in the payload of CFRA RAR will be discussed below.

2. Uplink Grant

Scenario 1:

First a scenario where the base station reserves no uplink grant for the user equipment will be considered.

If the UL grant is included in the RAR MAC PDU, then the user equipment 2 will discard information of UL grant in the case that the relevant RAR has been retransmitted for more than a specific number of times. The reason for this is that the received UL grant may have expired and the base station 1 has scheduled the resource to another user equipment. This means that the user equipment 2 will only apply the UL grant in RAR without any HARQ retransmission. This can be achieved at the side of the user equipment 2 by means of the NDI information.

This means that after the user equipment 2 decodes the RAR correctly, if the value of the NDI is changed from the value of the NDI borne in the PDCCH during previous MAC transmission, that is, there is new data being transmitted, then this means that no HARQ retransmission is applied to the RAR, so the UL grant is valid.

On the other hand, if the value of the NDI is unchanged from the value of the NDI borne in the PDCCH during previous MAC transmission, that is, there is no new data being transmitted, then the RAR has been subjected to HARQ retransmission at least once, so the UL grant is not valid any longer and shall be discarded.

At the base station side, if the NACK is received for the first-time transmission of the MAC PDU including the RAR, then the base station 1 can reschedule the uplink resource indicated in the UL grant to another user equipment or release the uplink resource to thereby prevent the uplink resource from being wasted. Thus, apparently the UL grant process will not be influenced by HARQ retransmission.

Scenario 2:

Then, a scenario where the base station 1 reserves the UL grant for the user equipment 2 will be considered.

Optionally, if the uplink resource waste is disregarded, then the base station 1 can reserve the UL grant for the user equipment 2 until the base station 1 receives the ACK. At the side of the user equipment 2, the UL grant can be applied when the RAR is decoded correctly. For example, the user equipment 2 will start to use the UL grant 4 ms after the RAR is decoded correctly, and the base station 1 can also know, upon reception of the ACK, that the user equipment 2 will use the UL grant 4 ms later.

The embodiments of the invention have been described above, but the invention will not be limited to any specific system, device or protocol, and those skilled in the art can make various variations or modifications without departing from the scope of the appended claims

Those ordinarily skilled in the art can appreciate and make other variations to the disclosed embodiments upon review of the description, the disclosure and the drawings as well as the appended claims. In the claims, the term “comprise” will not preclude another element(s) and step(s), and the term “a” or “an” will not preclude plural. In the invention, “first”, “second”, etc., are intended to merely represent a name instead of a sequential relationship. In a practical application of the invention, an element can perform functions of a plurality of technical features recited in a claim. Any reference numeral in the claims will not be construed as limiting the scope of the invention.

1. A method, in a base station, of transmitting a random access response message to a user equipment, the method comprising:
receiving a contention free random access preamble from the user equipment;
transmitting a random access response message to the user equipment in a first media access control protocol data unit;
transmitting a second media access control protocol data unit to the user equipment in a hybrid automatic repeat request process of the first media access control protocol data unit including the random access response message, wherein a physical control channel corresponding to the hybrid automatic repeat request process includes an indicator for indicating that the second media access control protocol data unit includes new data, the indicator being used for indicating whether the media access control protocol data unit is transmitted for a first time or retransmitted.

2. The method according to claim 1, wherein the first media access control protocol data unit includes an uplink resource allocated to the user equipment, and before the transmitting a second media access control protocol data unit, the method further comprises:
releasing or reallocating the uplink resource in the first media access control protocol data unit upon reception of a negative acknowledgement message from the user equipment or when no feedback from the user equipment is received in a predetermined period.

3. A method, in a base station, of transmitting a random access response message to a user equipment, the method comprising:
receiving a contention free random access preamble from the user equipment;
transmitting a random access response message to the user equipment in a media access control protocol data unit; and
retransmitting the media access control protocol data unit including the random access response message to the user equipment upon reception of a negative acknowledgement message from the user equipment or when no feedback from the user equipment is received in a predetermined period.

4. The method according to claim 3, wherein the media access control protocol data unit further includes an uplink grant, and a physical control channel corresponding to the media access control protocol data unit further includes an indicator for indicating whether the media access control protocol data unit includes new data, the indicator being used for indicating whether the media access control protocol data unit is transmitted for a first time or retransmitted.

5. The method according to claim 3, wherein the media access control protocol data unit further includes reception time when the base station receives the contention free random access preamble from the user equipment.

6. A method, in a user equipment, of processing a random access response message from a base station, the method comprising:
transmitting a contention free random access preamble to the base station serving the user equipment;
receiving from the base station the random access response message transmitted in a media access control protocol data unit;
determining whether the random access response message satisfies a predetermined validity condition; and
determining that the random access response message is valid when the random access response message satisfies the predetermined validity condition.

7. The method according to claim 6, wherein the predetermined validity condition comprises any one of:
the random access response message further including reception time when the base station receives the contention free random access preamble from the user equipment, and the user equipment decoding the random access response message successfully and determining that the random access response message is valid according to the reception time when the base station receives the contention free random access preamble from the user equipment and a reception window of the current random access response message;
the user equipment decoding the random access response message successfully, and a moment corresponding to a first-time transmission of the random access response message being within the reception window of the current random access response message;
the user equipment decoding the random access response message successfully; and
the user equipment decoding the random access response message successfully and a timing advancement value in the random access response message is valid.

8. The method according to claim 6, wherein after the determining that the random access response message is valid when the random access response message satisfies the predetermined validity condition, the method further comprises:
performing an uplink transmission with timing advancement information in the random access response message and starting or restarting a timing alignment timer upon determining that the random access response message is valid.

9. The method according to claim 6, wherein after the determining that the random access response message is valid when the random access response message satisfies the predetermined validity condition, the method further comprises:
determining an uplink grant in the random access response message satisfies a predetermined condition upon determining that the random access response message is valid;
performing a subsequent uplink transmission with the uplink grant included in the currently transmitted media access control protocol data unit when the random access response message satisfies the predetermined condition.

10. The method according to claim 9, wherein the predetermined condition comprises any one of:
the base station notifying that the uplink grant of the user equipment is not reserved, and the random access response message decoded successfully by the user equipment being transmitted for a first time; and
the base station notifying that the uplink grant of the user equipment is reserved for a predetermined period, and the user equipment decoding the random access response message successfully.
